(19) United States
(12) Patent Application Publication
(10) Pub. No.: US 2006/0091717 A1
(43) Pub. Date: May 4, 2006

(54) Seatbelt wrinkle stop and comfort spacer

(76) Inventor: James Blakeley Bonfield II, Sacramento, CA (US)

Correspondence Address: James Blakeley Bonfield II, 3828 Robertson Ave., Sacramento, CA, 95821, US

(21) Appl. No.: 11/268,199

(22) Filed: Nov. 4, 2005

Related U.S. Application Data
(60) Provisional application No. 60/625,029, filed on Nov. 4, 2004.

(51) Int. Cl. B60R 22/18

(52) U.S. Cl. 297/482

(57) ABSTRACT

A seat belt separation device is disclosed which attaches to the seat belt and provides separation between the seat belt and the wearer's clothes, thus preventing the clothes from being wrinkled. Protrusions extend from the device which are formed of a sufficiently compliant material to compress under load, such as during hard braking or collision, so that the operation of the seat belt is not adversely affected. One or more of the devices may be placed on the seat belt as desired by the user. Logos and other indicia may be displayed on the exterior of the device or on a cover coupled to or attached to the device. The indicia may comprise any desired form, including school logos, branding symbols, and the like, which these may provide an inducement for use of the devices and the seatbelts as well.

### CROSS-REFERENCE TO RELATED APPLICATIONS

This application claims priority from provisional patent application Ser. No. 60/625,029 filed Nov. 4, 2004 and to provisional patent application Ser. No. 60/______ filed Dec. 20, 2004; which are both incorporated herein in their entirety.

### BACKGROUND OF THE INVENTION

1. Field of the Invention

This invention pertains generally to automotive safety seat belts and more particularly to an apparatus which attaches to seat belts for increasing convenience and usage.

2. Description of the Background Art

The safety advantages of wearing seat belts when driving or riding in an automobile have been well known for decades. Tragically, many accidents still arise each year in which the occupants were not wearing their seat belts. Safety organizations as well as the police and highway patrols stress the use of safety belts in various programs conducted as safety announcements, programs for high schools and colleges and any other venues by which the safety message can reach the public. It is well understood that the proper wearing of seat belts can reduce injuries and death arising from auto accidents.

Accordingly it is important to reduce or eliminate the excuses for not using the seat belt or otherwise to induce drivers and passengers to “buckle-up”. The Seat Belt Wrinkle Stop and Comfort Spacer in accordance with the present invention satisfies that need, as well as others, and overcomes deficiencies in previously known inducements.

### BRIEF SUMMARY OF THE INVENTION

The present invention is a spacer that attaches to the seat belt to provide added comfort and to eliminate or reduce the wrinkling effect of the seat belt against the clothing of the wearer. The spacer is particularly well-suited for use on the shoulder portion of the seat belt, although it may be utilized with good results on the lap-belt portion as well. By way of example and not limitation, the seat belt spacer according to the present invention slidably attaches to the seat belt and is configured with soft protrusions extending from at least a first side. The tips of the protrusions are configured for making contact with the garments of the wearer, lifting the belt up and away from contact with the fabric of the garment, thus reducing belt contact with the wearer's garment which otherwise leads to wrinkle formation. Multiple spacers may be attached to a single seat belt to maintain separation across the span of the seat belt. Typically, one or two seat belt spacers would be utilized by an occupant, although any number could be made use of, such as three or more.

In response to high G-loading of a deceleration event, such as in response to hard vehicle braking or a collision, the soft spacer temporarily compresses, flattening, allowing the seat belt to operate conventionally, applying fairly even pressure across the torso. It should be readily recognized that the use of hard protrusions from the spacer would create dangerous pressure points in response G-loading during collision and is not a part of the invention's design.

In one embodiment, two protrusions extend from the device toward the wearer. The slidable engagement on the seat belt allows the device to be slid to the most appropriate location for the individual or person. One embodiment of the device is manufactured from a molded polymeric foam material for the spacer and using a molded polymeric cap to enhance retention and provide a base upon which artwork of the user's choosing or manufacturer design can be printed. The slidable engagement preferably is retained at a given position with a friction fit, until manually readjusted to a new position along the length of the seat belt. The spacer may be retained by any convenient means on the seat belt. A retention cap on the facing side in one embodiment maintains securement of the spacer on the belt while beneficially providing the location upon which artwork that may include graphics and/or text and so forth, may be printed or adhered. An example might be a High School team emblem and so forth, to provide additional incentives for use and making the seat belt more noticeable, which also should lead to increased utilization.

An aspect of the invention is to provide an inducement for increased seat belt utilization.

Another aspect of the invention is to provide increased user comfort by providing for greater ventilation and padded contact.

Another aspect of the invention is to provide a device that allows seat belts to be utilized without crushing clothing or creating wrinkles.

Another aspect of the invention is to provide a device that does not hinder the retraction of seat belts.

Another aspect of the invention is to provide a device upon which text and graphics including logos and so forth may be exhibited to enhance desirability of seat belt use.

Another aspect of the invention is to provide a device which can be manufactured in a one or two piece design.

Another aspect of the invention is to provide a device that can be readily and inexpensively manufactured for distribution within safety programs and campaigns.

Still another aspect of the invention is an ability to retain itself in a given position on the seat belt until manually readjusted to a new location.

Further aspect and advantages of the invention will be brought out in the following portions of the specification, wherein the detailed description is for the purpose of fully disclosing preferred embodiments of the invention without placing limitations thereon.

### DETAILED DESCRIPTION OF EMBODIMENT(S)

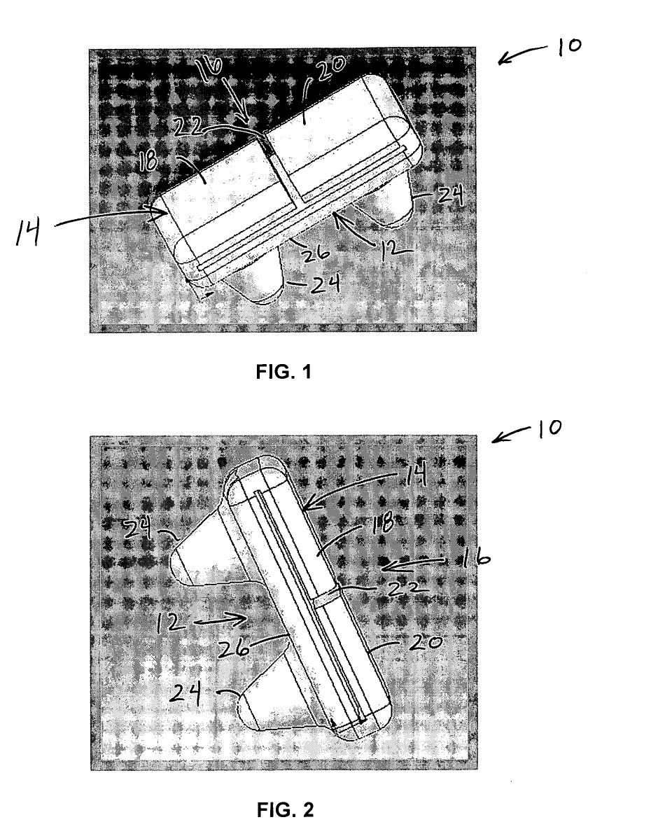

Referring more specifically to the drawings for illustrative purposes, the present invention is embodied in the method generally described in FIG. 1 to FIG. 18. The following description is presented to enable one of ordinary skill in the art to make and use the invention as provided in the context of a particular application and its requirements. Unnecessary technical details, which extend beyond the necessary information allowing a person of ordinary skill in the art to practice the invention, are preferably absent for the sake of clarity and brevity. Furthermore, it is to be understood that inventive aspects may be practiced in numerous alternative ways by one or ordinary skill without departing from the teachings of the invention. Therefore, various modifications to the preferred embodiments will be readily apparent to those skilled in the art, and the principles defined here may be applied to other embodiments. Thus the present invention is not intended to be limited to the embodiments shown, but is to be accorded the widest scope consistent with the principles and novel features disclosed herein.

Throughout the specification numerous values and type designations may be provided for the elements of the invention in order that a complete, operable, embodiment of the invention be disclosed. However, it should be understood that such values and type designators are merely representative and are not critical unless specifically so stated. The scope of the invention is not limited to one or more specific exemplifications within a described embodiment.

In one embodiment of the invention, the seatbelt wrinkle stop device consists of two parts. The body of the apparatus may be generally referred to as the “spacer” including a means for attachment to the seat belt and at least one protrusion made of a soft material, such as a stiff foam rubber, or similar material. The protrusions extending from the spacer serve to lift (separate) the seatbelt off the users chest and clothing in a way that relieves the wrinkle-causing contact often occurring from direct clothing contact with the seatbelt material. Further, by allowing only two small contact points to meet the garment, the belt can remain in place as intended, while reducing the actual belt surface area that contacts the garment to be reduced significantly.

The seat belt spacer device is connected to a seatbelt of a vehicle in a wrap-around fashion through its separation in the top of the molded piece. The opening is preferably sized to allow just enough room for a standard seatbelt (i.e. US standards, or that of the designated place of use) to fit into the space of the belt opening. In this embodiment the slot has sufficient depth to allow the spacer to be manually slid up and down the length of the belt to allow the user to position the spacer unit for maximum comfort and effectiveness. The seat belt spacer device can be configured to retain its position unloaded or in response to a slight application of belt pressure, depending on the particular implementation. The ability for user-defined placement also adds to the utility of the product by allowing people of different shapes and sizes to use the product with the same beneficial effects. A single seat belt spacer implementation can thus provide one-size-fits-all benefits to every user.

FIG. 1 and FIG. 2 illustrate pictorial views of an embodiment 10 of the seat belt spacer according to the invention, shown without the optional cap portion. A body 12 is shown with attachment means 14 shown by way of example as a split front portion 16 having a first section 18 and second section 20. A slot 22 through the center of body 12 is configured for slidably engaging the seat belt (not shown). The interior of the slot may include small protrusions, ridges, or similar adaptations to alter the friction fit of body 12 on the seat belt.

Compliant protrusions 24 are shown extending from a rearward portion 26 of base 12 to reduce the points of contact (under normal conditions), between the seat belt and the clothes of the vehicle occupant. In this way the extended supports prevent the seat belt from crushing a swatch of clothing crossed by the seat belt.

The spacer (i.e. polymeric, rubber materials, and so forth) material was selected with particular attention to its compression ratio. While the material is firm enough to lift the belt off the clothing surface (under normal low-G tension conditions), it is also able to compress to such a degree that should an impact occur (i.e. which causes the seatbelt tensioners to act as intended) the spacer will flatten in such a way as to not cause any interference with the seatbelts intended purpose of retaining the occupant. Furthermore, the compressibility of the protrusions do not place undue point stress upon the occupant which could increase injury. In addition, the material is non-allergenic and will not mark or otherwise transfer its color or material to the clothing of the user that it comes into contact with.

The material was selected for its ability to be fabricated (i.e. molded) in a wide array of colors while providing for a low degree of friction with most often used clothing materials and fabrics.

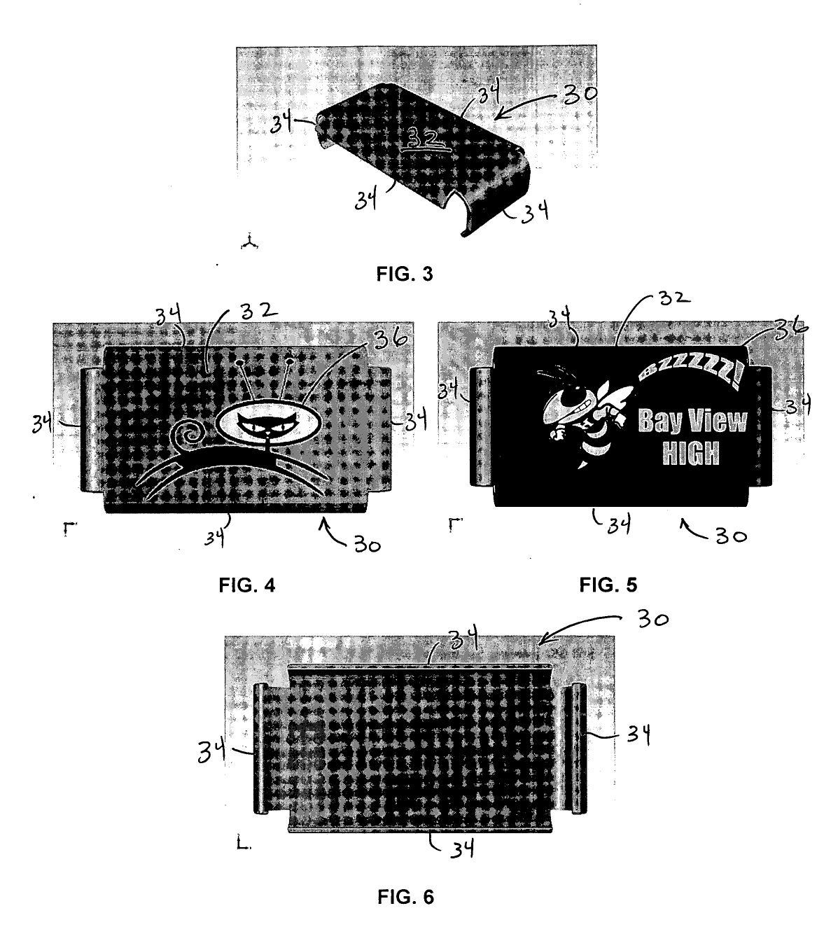

FIG. 3 through FIG. 6 illustrate an example of the second part of the product, which is herein referred to as the cover 30. Although the cover provides a number of benefits, in at least one embodiment of the invention it is considered optional. This embodiment of the spacer consists of a top 32 and four sides 34 that serve to effectively wrap around the base member of the spacer using tension to clamp the spacer to the belt in a way that allows the spacer to move up and down the belt without being subject to loss of contact from the belt.

The top surface of cover is designed in such a way as to allow text and/or graphics 36 to be displayed, to allow significant logo or printed message space to be delivered. This message space can be utilized, for example, to convey information about a specific campaign, a sponsoring organization, a logo or image that adds a customized appearance to the user's vehicle and so forth.

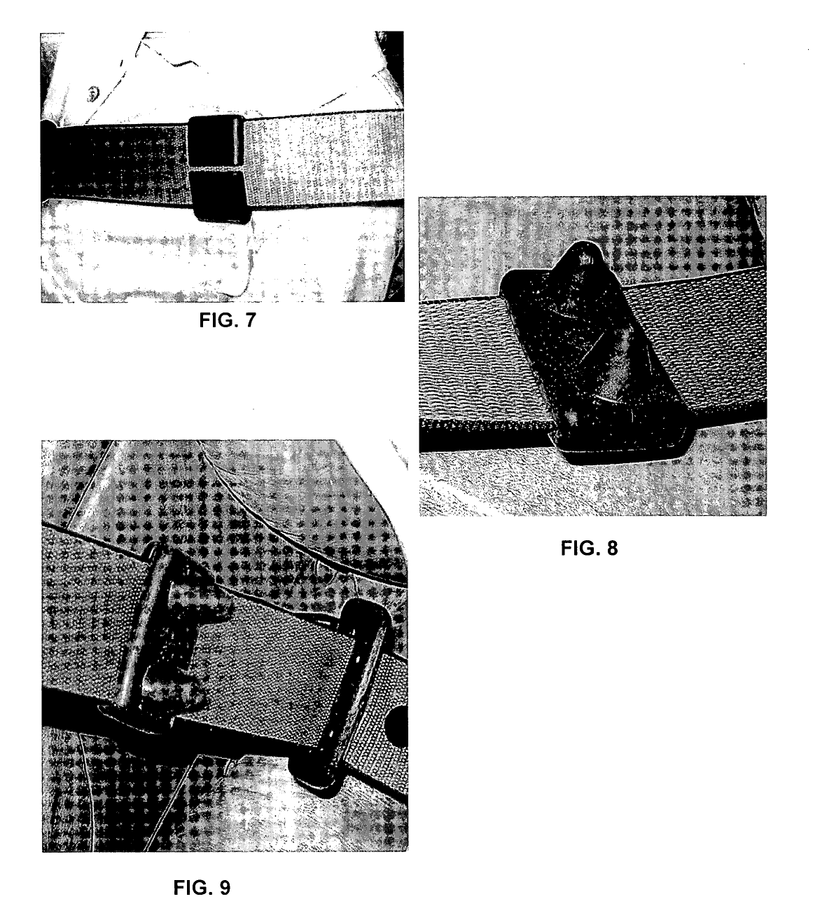

FIG. 7 illustrates the seat belt spacer of FIG. 1-FIG. 2 shown attached to the belt portion of a seat belt, without the use of an optional retention cover. The protrusions are facing in the opposite direction, against the occupant in this view. It will be appreciated that the spacer device can be implemented as a single piece which utilizes any of a number of attachment means for retention upon the belt portion of the seat belt.

FIG. 8 depicts a detailed view of the seat belt spacer attached to the belt of a seat belt, shown with twin rounded conical protrusions shown extending vertically.

FIG. 9 illustrates the seat belt spacer retained on the belt portion of a seat belt in a reversed direction, such as for retaining a child's car seat. In this instance the seat belt spacer is not configured to provide it's “non-wrinkling” advantages, but is stored on the belt for later use (after reversal) upon removal of the car seat, or other retained item. It should also be appreciated, that this mode allows a user to elect not to use the seat belt spacer to protect their clothing if they should so choose.

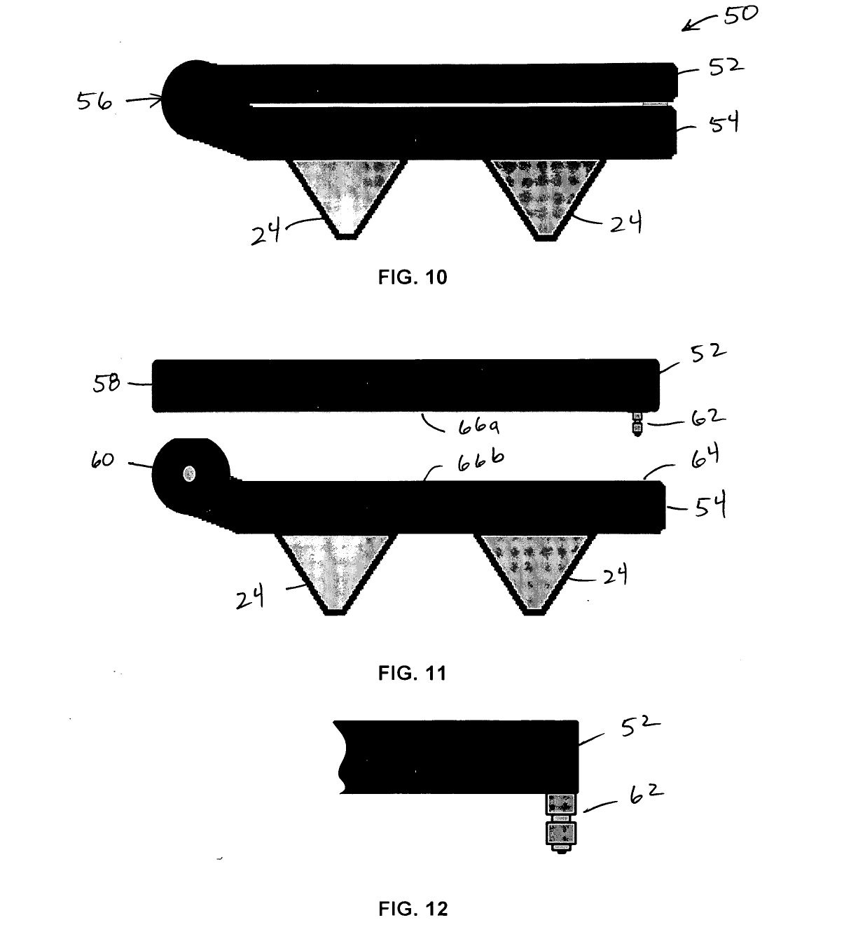

FIG. 10 through FIG. 18 illustrate by way of example embodiment a seat belt spacer 50 having a one piece body with insertable wrinkle abatement protrusions. FIG. 10 depicts the device in an operational position, as it would be on a seat belt. A first portion (upper) 52 and second portion 54 (lower) are shown coupled to one another, by way of example at a hinge 56, although other forms of attachment may be implemented. Protrusions 24 extend from second portion 54. Shown are two protrusions, although one, two, three, four, or a number of protrusions may be utilized. The preferred range is between one and four protrusions, with two being the most preferred.

This seat belt spacer device 50 is shown with a hinge that couples a first piece which retains the protrusions to a second piece therein allowing attachment to the seat belt. FIG. 11 depicts the first and second pieces unhinged in preparation for joining. Hinge section 58 of first portion 52 is configured to engage hinge section 60 of second portion 54. The interior surfaces of first and second portions 52, 54 are adapted for slidably engaging a seat belt. These may be configured for remaining in a fixed position subject to being readily slid into a new position, being held firm until moved, or sliding easily out of the way, so that automatic retraction mechanisms are able to fully retract the seat belt.

FIG. 12 depicts non-permanent fastener 62 extending from one of the portions, shown as the first portion 52, and adapted for being received in a receptacle 64 on the opposing surface, shown as second portion 54.

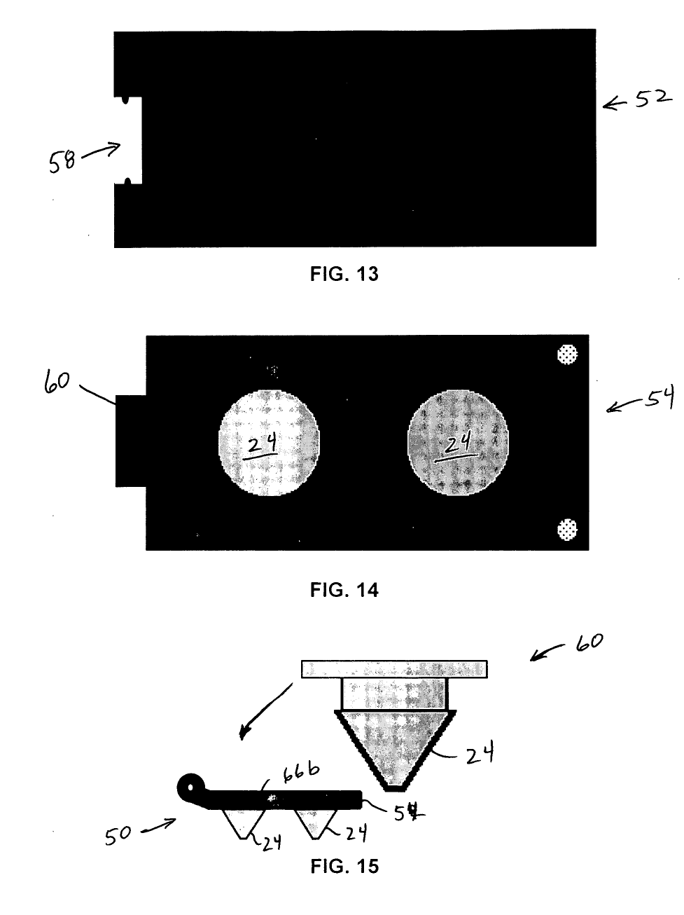

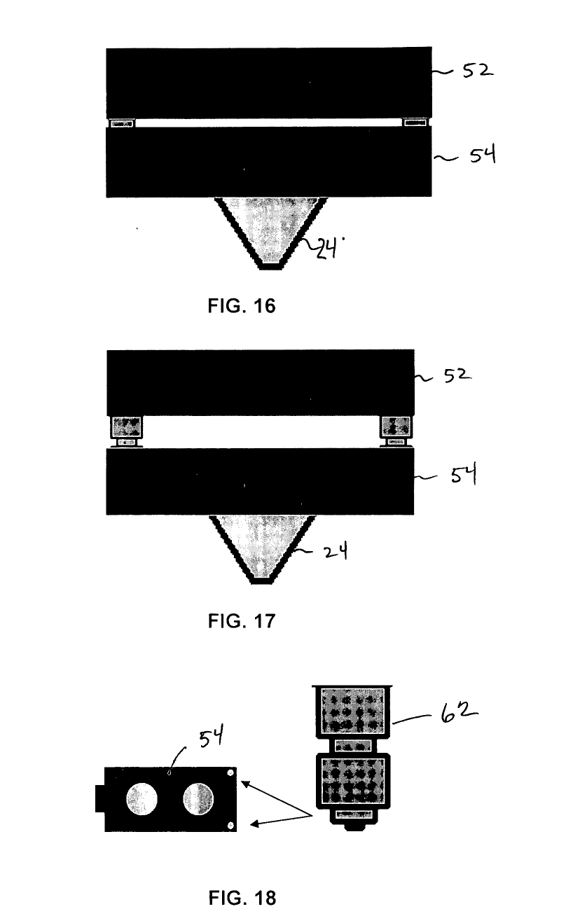

FIG. 13 and FIG. 14 depict top views of the first and second portions of the spacer. The top piece is shown having two mounts protruding from the hinge indentation to allow for the bottom piece to “snap” in to place creating the hinged joint. FIG. 16 and FIG. 17 depict opposing ends views of the spacer device. Manufacturing the body from a stiffer plastic with a sufficient gap between the first and second pieces allows the spacer to more readily “release” when user disconnects the seat belt and the seat belt retracts. The belt of the seat belt slides freely through the spacer wherein the retraction mechanism works conventionally without hanging up.

FIG. 12 depicts a fastener used for joining the two portions of the spacer. The first and second portions of the spacer body are connected at one point by a hinge, or similar attachment, while on an opposing side the portions join with a fixed or removable means of fastening. In the example shown two pins extends from one portion to engage mating receptacles on the opposing structure. It will be appreciated that one of ordinary skill in that art can adapt the spacer with a variety of conventional fastening forms without departing from the teachings of the present invention. FIG. 18 illustrates an example of the engagement pin for retaining the halves of the seat belt spacer.

FIG. 15 depicts an example of a separate protrusion 60 element configured for insertion within the hinged body of the spacer, depicted as second (lower) portion 54. It should be appreciated that the spacers may be formed with one or more separate protrusions which are separately coupled to the spacer housing, or multiple protrusions may extend from a single element that is retained in the housing. The top and bottom pieces are preferably molded from plastic. The bottom piece is shown with two cut-outs to allow for the rubber “spacer cones” to be pushed through and held in place through the rubber compressing and expanding against the plastic sides of the cutouts. It will be appreciated that the protrusions can be manufactured in a variety of shapes, colors, materials and compressibility ranges wherein the distributor or end user can be provided with a number of options. For example a kit can be provided with a plurality of protrusions allowing the user to customize their seat belt spacer with protrusions having the desired characteristics.

In this embodiment the protrusions comprise a material having a suitable compressibility wherein spacing is maintained under belt tension, while allowing compression of the protrusions in response to an incident/accident in which the passenger is restrained by the seat belts.

In use this embodiment of the invention opens at the “hinge point” to attach to the belt. The device is shown for clipping around the belt using a two-phase, “push-in post” preferably having two (or more) engagement positions to provide the desired fit. For example, when retracting the belt and leaving the spacer device mounted to the belt, the user can “snap” the unit open by one “notch” allowing the space between the top and bottom pieces to open widely enough to allow the belt to slide through and the spacer device to remain loosely affixed to the belt. The posts can also allow the option of clamping the spacer more securely during use, while slightly opening the spacing to allow the belt to slide through upon release and retraction of the belt.

In another implementation of the invention it should be appreciated that the hinge means shown in FIG. 10-14 can be implemented with various hinge styles. For example, one preferred embodiment utilizes a “living hinge” wherein the first and second portions 52, 54 of the device can be molded in a single piece with a thin section of material disposed therebetween forming the living hinge which flexes to allow closing portions 52 and 54 about the seat belt. In addition, the non-permanent fastening means depicted in FIG. 10-14 can be implemented with any desired form of fastener. By way of example the fastener may comprise a two-stage snap latch, although any form of conventional latching or fastening can be utilized.

Logos and the like may still be festooned on the exposed surface of the spacer device, in a similar manner as was depicted with respect to the previously described embodiment.

The figures and description of the seat belt spacer are shown as examples of practicing the invention. Construction of the seat belt spacer, as well as many alternative implementations, would be apparent to one of ordinary skill in the art based on the teachings herein.

The aspects, modes, embodiments, variations, and features described are considered beneficial to the embodiments described or select applications or uses; but are illustrative of the invention wherein they may be left off or substituted for without departing from the scope of the invention. Preferred elements of the invention may be referred to whose inclusion is generally optional, limited to specific applications or embodiment, or with respect to desired uses, results, cost factors and so forth which would be known to one practicing said invention or variations thereof. For example, one of ordinary skill may find other suitable substitutes as the following which are described without limitation: shapes and number of protrusions, material of the base member, use of separate protrusions that attach to base member or the use of integrated protrusions, type and characteristics of the compliant material forming the protrusions, means of attaching the base member to the belt portion of the seat belt, and optional elements such as the disclosed cover which can aid in displaying text and graphics as well as providing other functionality, such as enhanced retention.

Moreover, a seat belt spacer according to the various embodiments of the invention may be provided with all with all of features described herein, or only portions thereof, which combinations may be practiced and/or sold together or separately. For example, a seat belt spacer may be manufactured and sold without the spacers which are provided for later printing and assembly, and so forth.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. An apparatus for attachment to a vehicle seat belt, comprising:
a base member configured for attachment to the belt portion of a seat belt; and
means for maintaining separation between said base member, with attached belt portion of the seat belt retained thereto, and the garments of an individual wearing the seat belt.

2. An apparatus for attachment to a vehicle seat belt, comprising:
a base member configured for attachment to the belt portion of a seat belt; and
at least one protrusion extending from said base member and configured for maintaining separation between said base member, with attached belt portion of the seat belt retained thereto, and the garments of an individual wearing the seat belt.

3. An apparatus as recited in claim 2, wherein said protrusion comprises a material construction which is sufficiently compliant so that it will deform in response to G-loading of the seat belt by the occupant during hard braking incidents or collisions.

4. An apparatus as recited in claim 2, further comprising a cover adapted to attach to said base member.

5. An apparatus as recited in claim 4, wherein said cover is configured to secure the attachment of said base member to the belt portion of a seat belt.

6. An apparatus as recited in claim 5:
wherein said cover attaches to said base member after said base member is attached to the belt portion of the seat belt; and
wherein said cover attached to said base member prevents the belt portion from disengaging from said base member.

7. An apparatus as recited in claim 4:
wherein said cover is configured for displaying text, graphics, or both; and
wherein said cover comprises a rigid plastic material.

8. An apparatus as recited in claim 2, wherein said base member is configured with two or more protrusions extending from said base member.

9. An apparatus as recited in claim 8, wherein said protrusions extending from said base member are tapered.

10. An apparatus as recited in claim 8, wherein said protrusions extending from said base member comprise a compliant foam material.

11. An apparatus as recited in claim 1, wherein said base member comprises:
a top portion; and
a bottom portion configured for attachment to said top portion so that a seat belt may be retained therebetween;
wherein said bottom portion is configured for retaining one or more protrusions within the apparatus.

12. An apparatus as recited in claim 11, wherein said attachment of top and bottom portions comprises a hinge assembly on a first side of the apparatus and a fastener on a second side, or sides, of the apparatus.

13. An apparatus for attachment to a vehicle seat belt, comprising:
a base member configured for attachment to the belt of a vehicle seat belt system;
a slot within said base member configured for receiving the belt portion of the seat belt system; and
at least one protrusion extending from said base member to maintain separation between a belt portion of a seat belt to which said base member is attached and the clothes of an occupant wearing the seat belt.

14. An apparatus as recited in claim 13, wherein said protrusion comprises a material construction which is sufficiently compliant so that it will deform in response to G-loading of the seat belt by the occupant during hard braking incidents or collisions.

15. An apparatus as recited in claim 13, further comprising a cover adapted to attach to said base member.

16. An apparatus as recited in claim 15, wherein said cover is configured to secure the attachment of said base member to the belt portion of a seat belt.

17. An apparatus as recited in claim 16:
wherein said cover attaches to said base member after said base member is attached to the belt portion of the seat belt; and
wherein said cover attached to said base member prevents the belt portion from disengaging from said base member.

18. An apparatus as recited in claim 15:
wherein said cover is configured for displaying text, graphics, or both; and
wherein said cover comprises a rigid plastic material.

19. An apparatus as recited in claim 13, further comprising a cover coupled to said base member.

20. An apparatus as recited in claim 19:
wherein said cover is configured for displaying text, graphics, or both.
